(19) United States
(12) Patent Application Publication
(10) Pub. No.: US 2013/0103606 A1
(43) Pub. Date: Apr. 25, 2013

(54) System and Method for Delivery Transporter Tracking and Recipient Notification

(71) Applicant: PACKTRAK, LLC, Savannah, GA (US)

(72) Inventor: William Neil Holliday, Hilton Head Island, SC (US)

(73) Assignee: PACKTRAK, LLC, Savannah, GA (US)

(21) Appl. No.: 13/659,580

(22) Filed: Oct. 24, 2012

Related U.S. Application Data
(60) Provisional application No. 61/551,051, filed on Oct. 25, 2011.
(60) Provisional application No. 61/704,914, filed on Sep. 24, 2012.

(51) Int. Cl. G06Q 50/28; H04W 4/02

(52) U.S. Cl. 705/333

(57) ABSTRACT

In a computer implemented method of delivery tracking, a tracking identifier corresponding to a planned delivery of an item is received. The tracking identifier is validated based on a manifest associated with a transporter. A signal representing a location of the planned delivery of the item is sent to a mobile device of a planned recipient of the item. The location of the planned delivery of the item is displayed on a map at the mobile device based on the signal. A status and a location of the transporter are sent to the mobile device of the planned recipient. The location of the transporter is displayed on the map based on a status determination that the transporter is en route.

### PRIORITY CLAIM

This application claims priority under 35 U.S.C. §119(e) from U.S. Provisional Pat. App. Ser. Nos. 61/551,051 entitled “System and Method for Delivery Transporter Tracking and Recipient Notification” filed Oct. 25, 2011 and from U.S. Provisional Pat. App. 61/704,914 entitled “Invention Expansion” filed Sep. 24, 2012, each of which is hereby incorporated by reference herein in its entirety.

### BACKGROUND

There are many situations when it is desirable for delivery recipients to know the location of the transporter en route and receive notifications as to the proximity and status of the delivery. This information also allows recipients to approximate the transporter arrival time, intercept the transporter en route before an attempted delivery, or intercept the transporter after a missed delivery attempt.

Existing systems track delivery vehicles. Existing systems provide delayed delivery tracking information to recipients. Existing systems provide electronic delivery notifications to recipients in the form of e-mail and text messages.

Inefficiencies and limitations within existing systems include: tracking delivery vehicles rather than tracking the people or cyborgs actually delivering the items, limited delivery tracking information provided to recipients, lack of real-time delivery tracking information provided to recipients, and limited delivery notifications provided to recipients.

### SUMMARY

In some embodiments, a computer implemented method includes receiving a tracking identifier corresponding to a planned delivery of an item. The tracking identifier is validated based on a manifest associated with a transporter. A signal representing a location of the planned delivery of the item is sent to a mobile device of a planned recipient of the item. The location of the planned delivery of the item is displayed on a map at the mobile device based on the signal. A status and a location of the transporter are sent to the mobile device of the planned recipient. The location of the transporter is displayed on the map based on a status determination that the transporter is en route.

In some embodiments, a system includes a server and a mobile device, each of which includes a computer processor, a radio transceiver, and a computer readable storage medium. The mobile device further includes a display. The computer readable storage medium of the server includes computer-executable instructions stored tangibly thereon. The instructions configured to, when executed, cause the processor of the server to perform the operations of: causing the transceiver of the server to receive, from the mobile device, a tracking identifier corresponding to a planned delivery of an item; validating the tracking identifier based on a manifest associated with a transporter; causing the transceiver of the server to send, to the mobile device, a signal representing a location of the planned delivery of the item, and causing the transceiver of the server to send, to the mobile device, a status and a location of the transporter. The computer readable storage medium of the mobile device includes computer-executable instructions stored tangibly thereon. These instructions are configured to, when executed, cause the processor of the mobile device to perform the operations of: causing the transceiver of the mobile device to receive the tracking identifier from a user of the mobile device; causing the transceiver of the mobile device to send the tracking identifier to the server, displaying, on a map on the display of the mobile device, the location of the planned delivery of the item, based on the signal received from the server, and displaying, on the map, the location of the transporter.

### BRIEF DESCRIPTION OF THE DRAWINGS

The following will be apparent from elements of the figures, which are provided for illustrative purposes and are not necessarily to scale.

FIG. 1 is a diagram of an embodiment of the present disclosure.

FIG. 2 is a diagram which indicates the physical components of the delivery system in accordance with an embodiment of the present disclosure.

FIG. 3 is a visual example of transporter movement within a delivery environment.

FIG. 4 is a high level schematic diagram which depicts the communication of data within the system.

FIG. 5 is a model of the data within the system.

FIG. 6 shows examples of certain elements within the data model.

FIGS. 7A and 7B illustrate a flow chart of a process in accordance with an embodiment of the present disclosure.

FIG. 8 is a flow chart of a process in accordance with an embodiment of the present disclosure.

FIGS. 9A, 9B, 9C, and 9D are visual examples depicting user interaction with a system in accordance with some embodiments.

FIG. 10 is a visual example depicting transporter interaction with a system in accordance with some embodiments.

FIG. 11 is a flow diagram of a process in accordance with some embodiments of the present disclosure.

FIG. 12 is a computer architecture diagram in accordance with some embodiments.

FIG. 13 is an illustration of a geofence in accordance with some embodiments.

### DETAILED DESCRIPTION

This description of certain exemplary embodiments is intended to be read in connection with the accompanying drawings, which are to be considered part of the entire written description.

The following terms used herein are defined as follows, however, such definitions shall be exemplary in nature and not meant to be limiting or exclusionary of the common meanings of such terms.

“Transporter”—A person assisted or enhanced by electronic devices—a cyborg—capable of transporting items from one location to another.

“Electronic device”—includes, but is not limited to, a piece of equipment or mechanism designed to serve a special purpose or perform a special function. Such devices may be nanoscopic in scale.

“Location enabled electronic device”—includes, but is not limited to, an electronic device which provides positional information by means of Global Positioning Systems (GPS), Cellular Positioning Systems (CPS), Local Positioning Systems (LPS), or any other compatible positioning systems.

“Recipient”—includes, but is not limited to, the person or business to whom the delivery is sent. This term may also include any individual delegated to, or in charge of, the task of receiving the delivery.

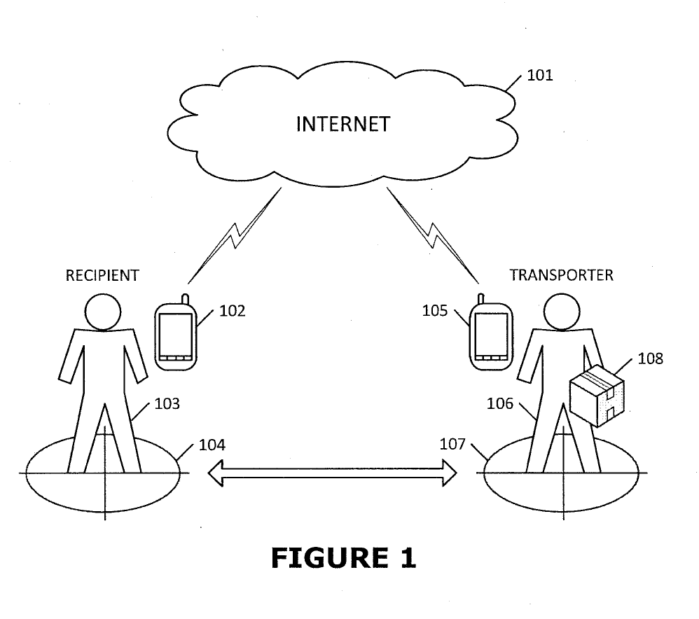

Referring now in more detail to FIG. 1, there is shown an embodiment of the present disclosure. The intended recipient of a delivery 103 tracks the transporter 106 with package 108 en route via an electronic device 102. The recipient's electronic device 102 may be location enabled. The transporter's electronic device 105 must be location enabled. Locations 104 and 107 may be determined by Global Positioning Systems (GPS), Cellular Positioning Systems (CPS), or Local Positioning Systems (LPS). Information is transmitted wirelessly to and from the internet 101. The wireless communication methods may include, but are not limited to, cellular networks, “wi-fi”, and quantum entanglement data transmission.

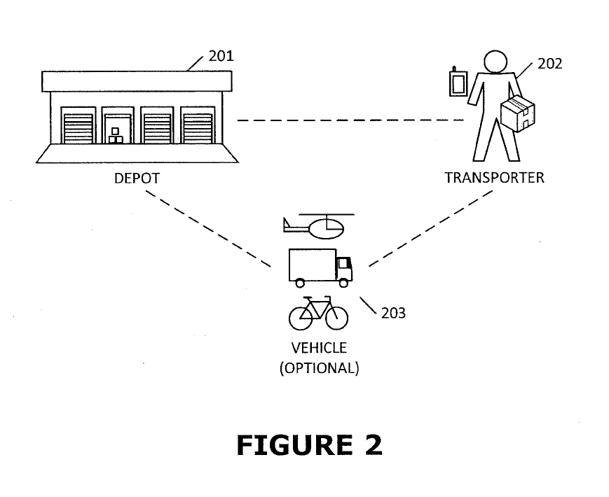

FIG. 2 is a diagram which indicates the physical components of the delivery system for an embodiment of the present disclosure. In this embodiment, a depot 201 is the origin of the delivery action. The transporter 202, who may be tracked continuously throughout the delivery process, is a person or cyborg capable of delivering the item to its final destination. The transporter and delivery item may require additional conveyance in the form of a vehicle 202 or appliance. Such vehicles include, but are not limited to, trucks, cars, airplanes, helicopters, motorcycles, bicycles, and horses. Transporter conveyance appliances include, but are not limited to jetpacks and skates.

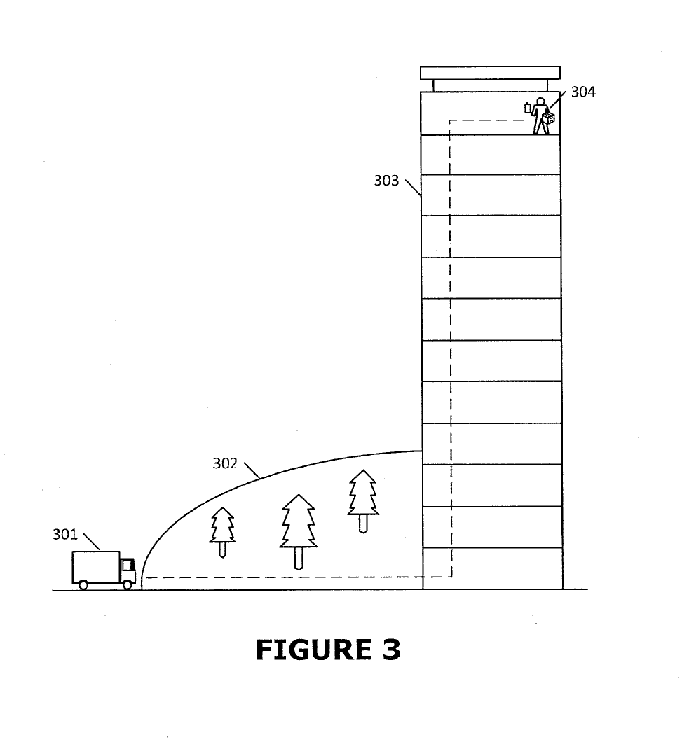

FIG. 3 is a visual example of transporter movement within a delivery environment. In this embodiment, the vehicle 301 has restricted movement within a campus 302 setting. The campus 302 may consist of office buildings, apartment buildings, educational buildings, and recreational facilities. The building 303 in this example contains multiple floors. While the transporter 304 navigates both the campus environment 302 and the multi-story building 303, delivery tracking information for the transporter is provided to the system. Location information may be facilitated through Global Positioning Systems (GPS), Cellular Positioning Systems (CPS), Local Positioning Systems (LPS), or location enabled sensors within the environment.

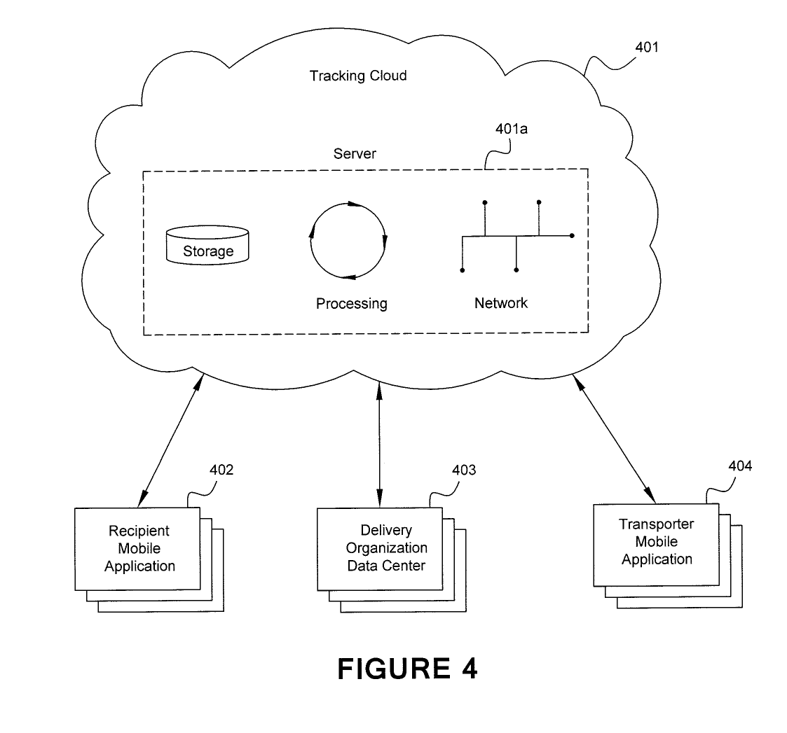

FIG. 4 depicts the movement of information within the system. The tracking cloud 401 includes a server 401a configured to store and processed tracking information sent and received by applications on multiple devices and data centers. Server 401a is also configured to communicate over a network with mobile devices 102, 105 of the recipient and transporter, respectively, and with one or more delivery organization data centers 403. Recipient mobile applications 402 at respective mobile devices 102 of recipients consume tracking information from the cloud. Transporter mobile applications 404 at respective mobile devices 105 of transporters provide transporter information to the cloud. Delivery organization data centers 403 both provide and consume tracking information which may correspond to delivery organizations 502.

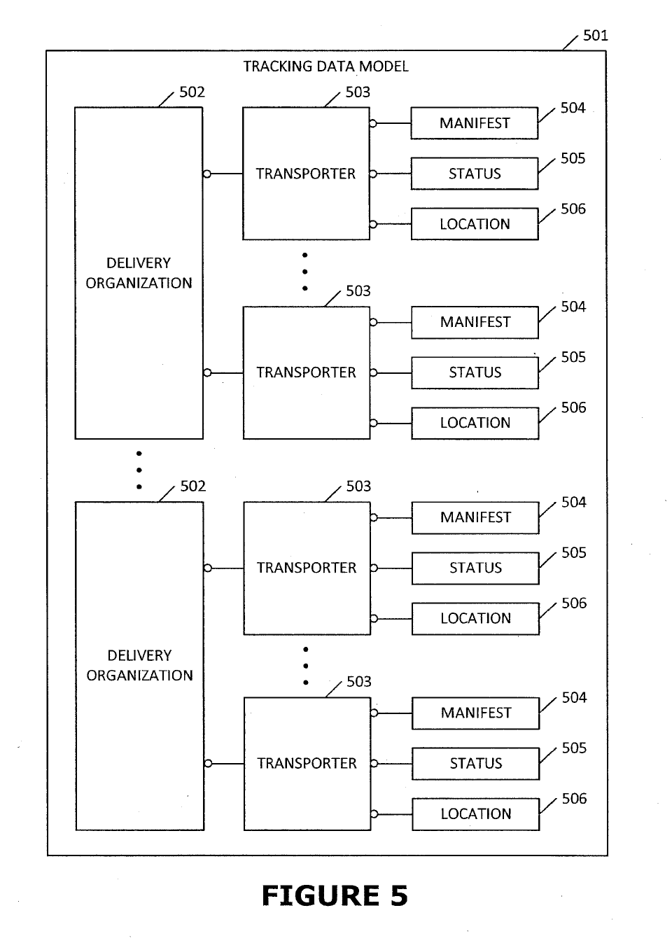

FIG. 5 defines a model for the data within the system. The tracking data model 501 consists of several elements. Each delivery organization 502 may have multiple transporters 503. Each transporter has an associated manifest 504, status 505, and location 506. Referring back to FIG. 4, data centers 403 may provide information to the tracking cloud 401 regarding respective delivery organizations, e.g., regarding transporters of various delivery organizations.

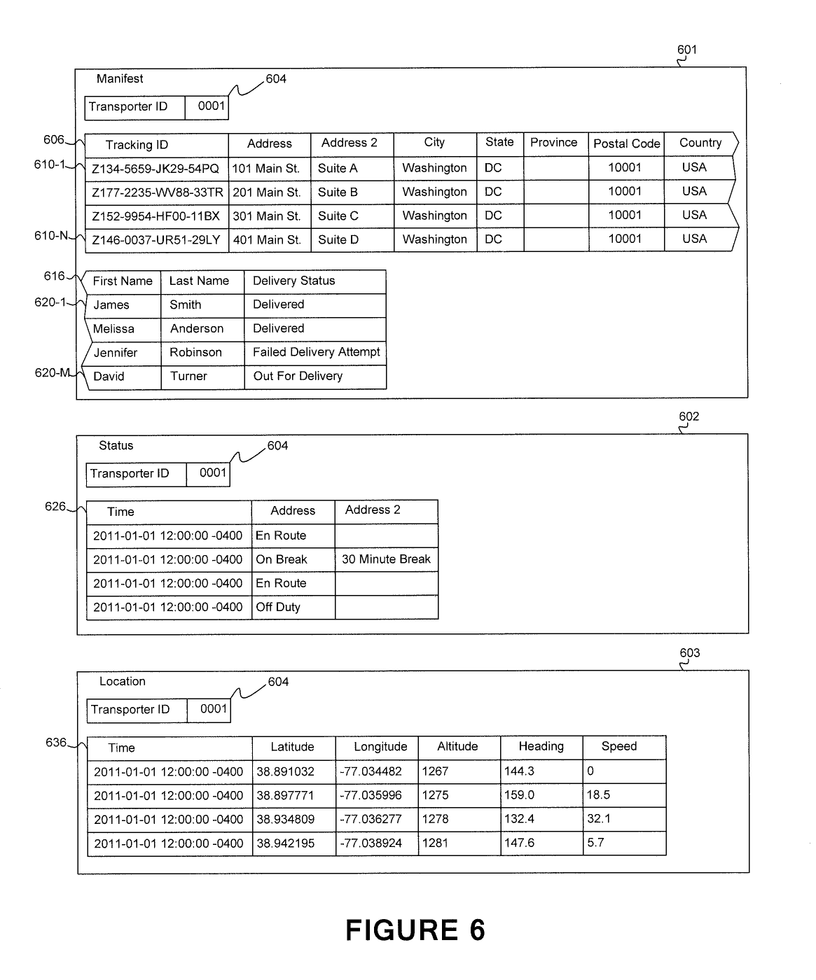

FIG. 6 presents examples of data associated with a transporter having a transporter ID 604 (in this example, the ID is “0001”). Various database storage and retrieval techniques may be used to access and modify information in the various data records shown in FIG. 6.

The manifest 601 describes delivery items assigned to the transporter. For example, a table 606 may store delivery information associated with the planned delivery of various items having respective tracking ID's 610-1, . . . , 610-N (collectively “tracking ID's 610”). Each item to be delivered may also be associated with a planned delivery address, shown in FIG. 6 with various address fields. A table 616 may store information about various planned recipients (i.e., persons to whom items are to be delivered) 620-1, . . . , 620-M (collectively “recipients 620”). Each recipient may have an associated delivery status in the table 616. The delivery status may indicate, for example, whether an item that was planned for delivery has already been delivered, experienced a failed (missed) delivery attempt, or is currently out for delivery.

The status data 602 indicates the availability of the transporter. For example, a table 626 may include information about a transporter's status (e.g., en route, on break, or off duty) at various times during the day. In the case of a break, the duration of the break may be stored.

The location data 603 of the transporter facilitates tracking within the system. In some embodiments, a table 636 may store various attributes such as latitude, longitude, altitude, heading, and speed of the transporter at respective times. The location data 603 may also provide a location for the transporter in terms of a street address, floor number, etc., as discussed further below.

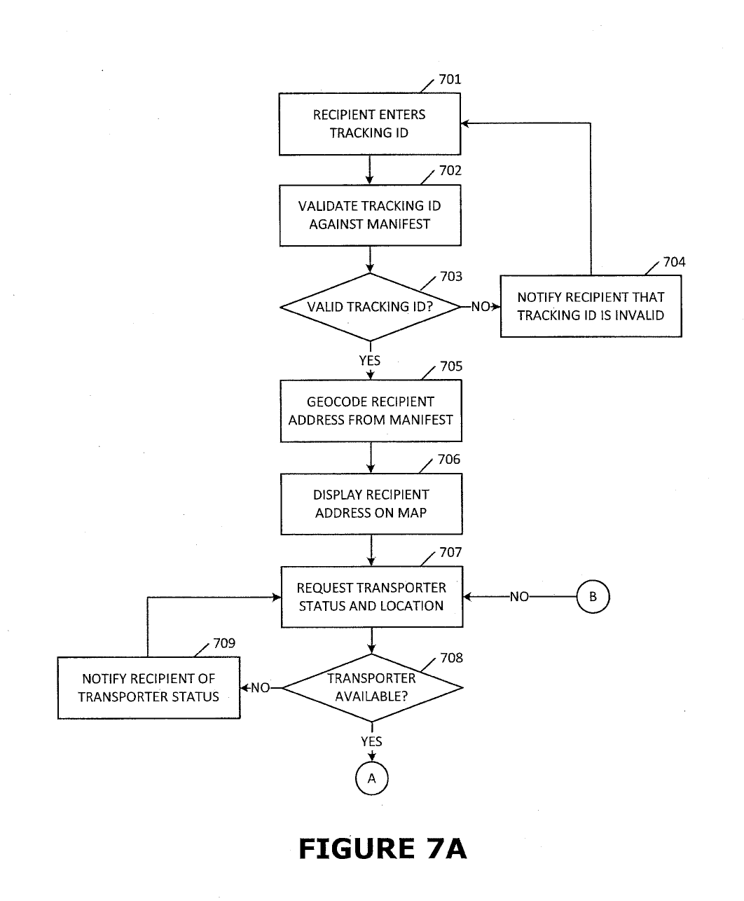

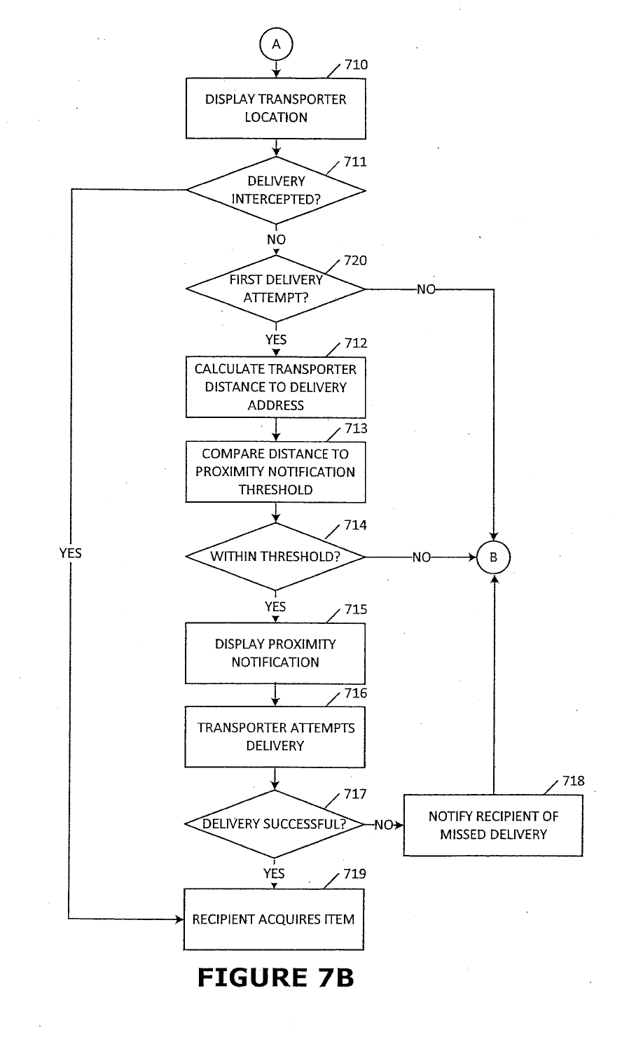

FIGS. 7A and 7B describe an exemplary computer-implemented process in accordance with some embodiments. The planned recipient 103 of an item enters (701) a tracking ID (corresponding to a planned delivery of the item) within mobile application 402. The system validates 702 the tracking ID against existing manifests. For example, referring to FIG. 6, the inputted tracking ID may be used as an index into table 606 to determine whether the inputted tracking ID is a valid tracking ID associated with a planned delivery. Validation of the tracking identifier based on a manifest 601 associated with a transporter 106 may occur at mobile device 102 in some embodiments, or may occur at server 401a, which may be a central server or a cloud-based server. For example, the tracking ID may be sent (e.g., wirelessly) to server 401a for validation. Upon validation 703, the recipient will receive notification if the ID is invalid 704; otherwise, the system will geocode the address associated with the tracking ID 705. The geocoding of the address data, which may convert address data into geographical coordinates for displaying on a map, may occur at mobile device 102 in some embodiments, or may occur at server 401a.

The planned delivery address (e.g., address location of the planned recipient 103) is then displayed on the map 706 within the mobile application 402. The system then provides (707) the status and location of the assigned transporter to the mobile application 402. The status may be one of “en route,” “on a break,” and “off duty”; other statuses may be defined by delivery organizations. The location of the transporter may be obtained based on geolocation functionality of the transporter's mobile device 105, e.g., via mobile application 404. For example, the transporter's mobile device 105 may be a smartphone that is GPS-enabled (e.g., having a GPS receiver and having a processor configured to interact with the GPS receiver to determine the device's location).

Upon determining the availability of the transporter (708), the recipient may receive notification of the transporter status 709 if the transporter is not available. In this context, “available” means “en route,” (e.g., currently traveling towards the delivery address in a vehicle or on foot) and more specifically, available for tracking. If the transporter is not available, the transporter status notification message may include an indication of a next availability time of the transporter (e.g., “Transporter's break ends at 1 pm”). If the transporter is available, the location of the transporter may be displayed 710 on the map within the mobile application. By observing the location of the transporter, the recipient may navigate to the transporter to intercept the delivery 711. Upon an intercept, the transporter may send to server 401a a notification that intercept has occurred.

If the delivery is not yet intercepted, and if a determination is made that the transporter is making a first delivery attempt (720), the system will calculate the distance between the transporter and the delivery address 712. This distance may be calculated at mobile device 102 in some embodiments, or may occur at server 401a. The calculated distance may be a birds-eye distance (e.g., straight line distance), a distance calculated along one or more navigable roads (e.g., taking into account delivery organization-specific considerations such as a preference for right turns), or a distance calculated based on a route determined by some other routing algorithm. The calculated distance is then compared to a predetermined proximity threshold 713. If the transporter distance is within the threshold 714, the recipient will receive a notification 715, e.g., “Transporter within 1 mile of delivery address”). Upon a delivery attempt by the transporter 716, if the delivery is successful 717, the recipient will acquire the item 719, or if the delivery is not successful 717, the recipient will receive notice of a missed delivery attempt 718. If the delivery is missed, the recipient may use the tracking map to navigate to the transporter and attempt to recover the item or may loop back to request transporter status and location 707. On subsequent iterations (i.e., after looping back to request transporter status and location 707), the check for “first delivery attempt” 720 returns NO, so a proximity notification may not be displayed to the planned recipient 103.

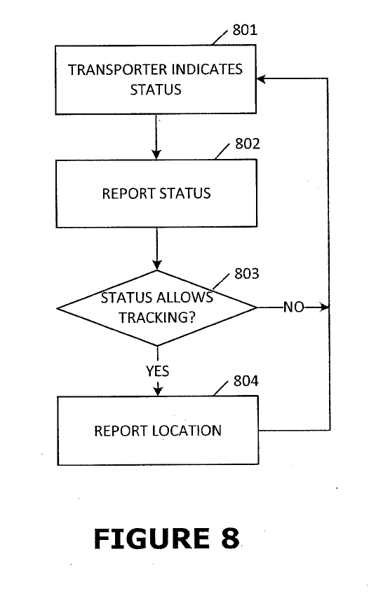

FIG. 8 describes another exemplary method and process of an embodiment of the present disclosure. The transporter 801 inputs his/her current status via the mobile application 404. The status is then reported 802 to the system. If the status is compatible with tracking 803, the transporter location is reported to the system 804.

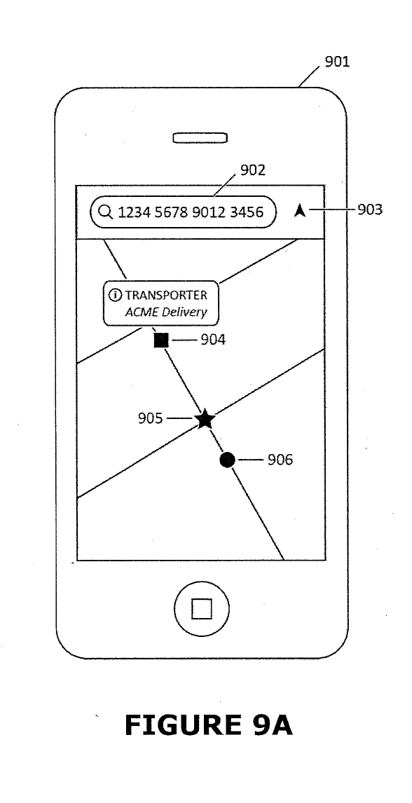

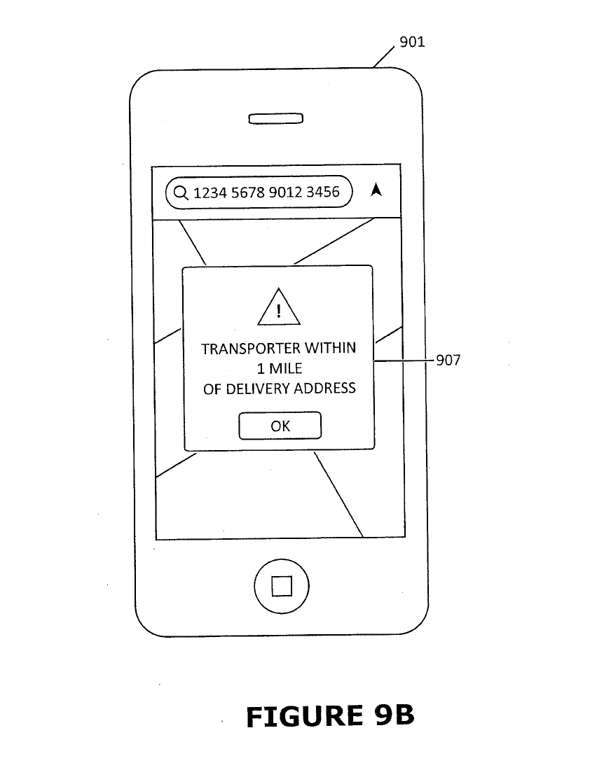

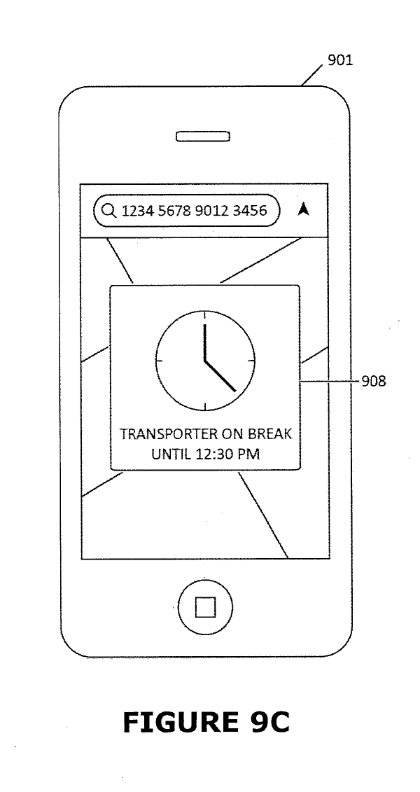

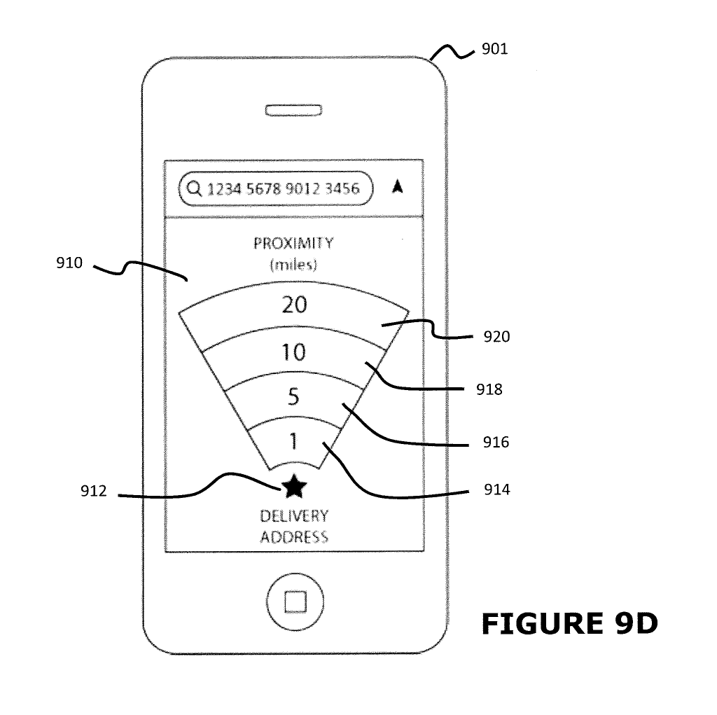

FIGS. 9A, 9B, and 9C are depictions of example screenshots regarding recipient interaction with the system. The planned recipient of the to-be-delivered item interacts with the system via an application 402 running on a mobile device 901, which may be the same as mobile device 102. Referring to FIG. 9A, the recipient enters a tracking ID 902 which is validated by the system. The transporter's location 904 and geocoded planned delivery address 905 are displayed on the map. In this example, the transporter is identified as being a transporter for the “ACME Delivery” delivery organization. The location of the planned recipient 906 may be displayed on the map when the recipient 906 activates the locator function 903.

Referring to FIG. 9B, a proximity notification 907 alerts the recipient to an imminent delivery attempt, e.g., by notifying the recipient that the transporter is currently within a predetermined distance (e.g., one mile) of the planned delivery location. Another proximity indication is shown in FIG. 9D, which is a depiction of an example screenshot regarding a proximity indicator diagram in accordance with some embodiments. The proximity indicator diagram 910 may be displayed (e.g., on a display of mobile device 901) to a recipient to alert him/her regarding a transporter who is approaching the planned delivery location. In the example of FIG. 9D, the distance between the transporter and the planned delivery address may be displayed based on various distance bins, e.g., whether the distance is less than one mile, between one and five miles, between five and ten miles, or between ten and twenty miles. Depending on the distance, a corresponding region 914, 916, 918, or 920 of the proximity indicator diagram 910 may be indicated. For example, region 916 may be illuminated if the transporter is currently 14.3 miles away from the delivery address (within twenty miles but not within ten mile). Over time, different regions may be illuminated as distance between the transporter and the planned delivery address changes.

Based on the information in the proximity indicator diagram 910, the recipient may determine that he/she has enough time to conduct various activities (e.g., go to the grocery store) before the transporter reaches the planned delivery address. In this way, deliveries can be more efficient for the transporter and delivery organization (because missed delivery rate will be lower when the recipients know when it is inadvisable to leave the delivery address) and also for the recipient (who can flexibly coordinate the delivery with other activities in his/her schedule). Various distance thresholds (e.g., other than one, five, ten and twenty miles) may be used in various embodiments. In some embodiments, the respective colors may be used for the regions in the proximity indicator diagram 910. For example, region 920 may be displayed in green when the transporter is between ten and twenty miles away from the delivery address, and region 914 may be displayed in red when the transporter is within one mile from the delivery address. Other color schemes may be used as well for respective regions.

In various embodiments, security risks for a transporter are mitigated by informing a recipient about proximity information, e.g., as in FIG. 9B or 9D, without revealing to the recipient the transporter's precise location. For example, in FIG. 9D, the precise location of the transporter may not be indicated to the recipient, and even the present distance between the transporter and the planned delivery location may be displayed with relatively coarse resolution, e.g., so that the recipient knows that the transporter is between 1 and 5 miles away from the delivery address but does not know the precise distance. In this way, transporters or delivery organizations who would otherwise be concerned about people knowing the exact location of transporters can be reassured.

In some embodiments, expanded intercept capabilities are supported. When a planned recipient of an item is navigating toward a transporter to intercept the transporter (e.g., after a missed delivery attempt, referring to FIG. 7B), security considerations are often relevant. For example, sometimes the transporter may be in a dimly lit area, in an area that may be considered unsafe, or simply too busy to participate in an intercept with the person who was supposed to receive a delivery (i.e., the planned recipient). The recipient may request an intercept via application 402. This request is routed via the tracking cloud 401 to mobile application 404 of the transporter. The transporter may accept or deny the intercept request.

Referring to FIG. 9C, the recipient may be notified of the current transporter status or a change in the transporter status 908. In this example, the recipient is informed that the transporter who is assigned to transport an item to the delivery address is currently on break until 12:30 pm.

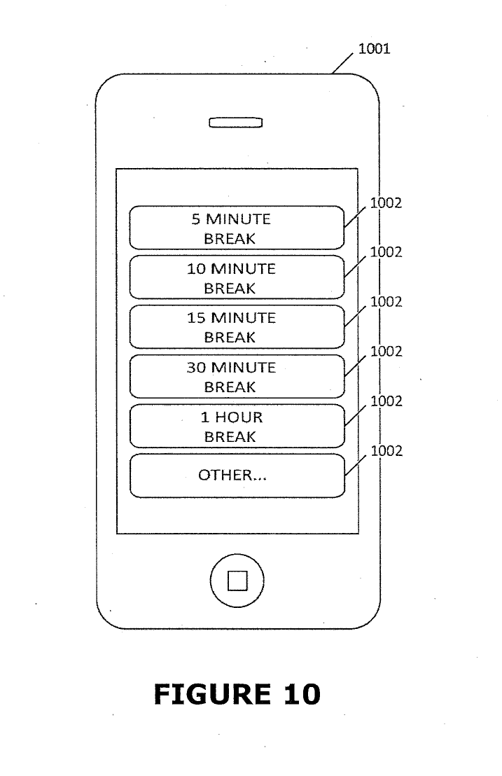

FIG. 10 illustrates transporter interaction with the system according to an embodiment of the present disclosure. The transporter interacts with the system via an application running on a mobile device 1001, which may be the same as mobile device 105. The transporter may change his status at any time. In this exemplary embodiment, the transporter may indicate that he is on a break of a specified amount of time 1002. This information is transmitted (e.g., wirelessly) to server 401a.

In some embodiments, the transporter is notified via an application running mobile device 1001 regarding the proximity of a planned recipient, who may be approaching the transporter. For example, a proximity indicator diagram similar to FIG. 9D or a notification message similar to FIG. 9B may be displayed to a transporter to inform the transporter than a planned recipient is approaching him/her, e.g., in order to intercept the transporter. The current location of the planned recipient may be obtained via geolocation functionality on the recipient's mobile device 901.

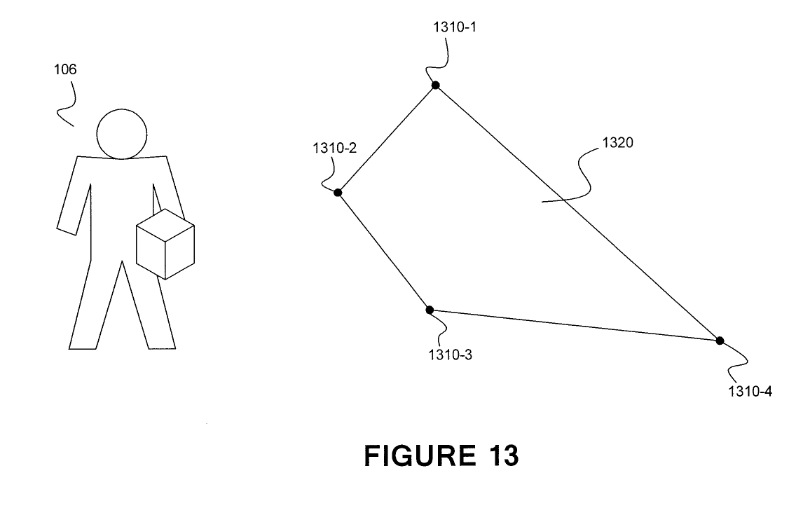

In some embodiments, delivery tracking functionality may only be selectively available, e.g., based on the transporter's location relative to a geofence. A geofence, which is a virtual perimeter for a geographic area, may be established for security purposes, e.g., to prevent sensitive information from being divulged. For example, referring to FIG. 13, a geofence may be established as a polygon having vertices 1310-1, 1310-2, 1310-3, 1310-4 defining a region 1320 there. Each vertex may correspond to latitude and longitude coordinates, for example. Any number of vertices may be used to define any shape, and the polygon may be convex or concave. As the transporter's location varies, the location is compared against the geofence. For example, various computational geometry techniques may be used for determining whether the point corresponding to the transporter's location is inside the polygon shown in FIG. 13. If the transporter's location is within area 1320, the transporter's location is not communicated to tracking cloud 401, and the planned recipient will be unable to receive proximity notifications or location updates regarding the transporter. A geofence may also be defined in other ways than based on a polygon. For example, a geofence may be established for a region within a predetermined distance from a point (i.e., a circular region), or based on a region having any other shape.

In some embodiments, a person who desires to use tracking functionality as described herein in the role of a recipient of items may first be screened for suitability based on that person's wireless communication capability. For example, suppose a person Sally lives in a remote area in which her mobile device 102 does not have the ability to connect to a wireless communication network of a predetermined quality (e.g., 3G or better; various metrics may be used to gauge quality). This determination may be made based on Sally's zip code (or other information that identifies her location), which is provided to tracking cloud 401. If her ability to communicate over a suitable wireless communication network is deemed inadequate, she may be informed that she will not be able to participate in tracking of the transporter as disclosed herein.

In some embodiments, when a person (e.g., Sally) orders an item using an electronic commerce application, she inputs a delivery address. If the specified delivery address is determined to correspond to a location where a mobile device does not have the ability to connect to a wireless communication network of a predetermined quality as described above, Sally will receive an electronic notification that she will be unable to track the transporter.

In some embodiments, a route for the transporter to take to reach the planned delivery address is initially determined. If it is determined that inadequate wireless communication capability is present at one more points along the route, tracking of the transporter is disabled. For example, if the transporter would only have adequate wireless signal strength for a portion of his/her route, the transporter or corresponding delivery organization may not desire to enable transporter tracking, so transporter tracking is disabled. In such a case, the planned recipient (e.g., Sally) receives an electronic notification that she will be unable to track the transporter.

In some embodiments, the planned recipient who is expecting a delivery of an item receives a notification of the position of that item within a delivery queue of the transporter. For example, the notification may specify that given item is the tenth item in the delivery queue (i.e., nine items have to be delivered before the given item). Such information about the status of the delivery queue may inform the planned recipient regarding when the transporter is likely to reach the planned delivery location. For example, if the recipient (e.g., Sally) observes that the transporter is within one mile of the planned delivery address but the transporter must first deliver a large number of items before delivering Sally's item, Sally may plan accordingly.

In some embodiments, the location of the transporter is obtained not by geolocating a mobile device of the transporter, but rather by geolocating a separate standalone device. For example, if a delivery organization does not provide its transporters with mobile devices (e.g., due to limited resources), a standalone tracking device may be included (e.g., by a retailer or shipper) with the item (e.g., in the same package as the item or attached to that package) before the item is sent for delivery. The standalone device may include geolocation hardware and/or software. For example, the standalone device may include a receiver configured to receive a positioning signal (e.g., GPS signal), a computer processor configured to determine a location of the tracking device based on the received positioning signal, and a transmitter configured to transmit to the server 401a a tracking signal representing the location of the tracking device. Because the standalone device will travel alongside the item that is to be delivered, and the item travels along with the transporter, tracking the standalone device is equivalent to tracking the transporter based on a mobile device of the transporter. In this case, the location of the transporter is considered to be essentially the same as the location of the item and essentially the same as the location of the standalone device. Providing tracking based on a standalone device may yield cost savings to the delivery organization because each transporter may not need to be equipped with a mobile device. In this way, smaller delivery organizations that do not have the financial resources of major delivery organizations can still provide a way for recipients to track transporters.

In some embodiments, the display of the transporter's location may be disabled when a predetermined condition is satisfied. For example, the display of the transporter's location may be disabled based on receipt of any of the following signals: reception of a signal corresponding to a request from the server to disable the display of the location of the transporter (e.g., due to security considerations); reception of a signal corresponding to a request from the transporter to disable the display of the location of the transporter (e.g., if the transporter is not comfortable with having his/her location being displayed); reception of a signal corresponding to insufficient wireless network accessibility for the mobile device 105 of the transporter (e.g., insufficient signal strength when the transporter is in a remote area), or reception of a signal corresponding to presence of the transporter within or near a predetermined geofence.

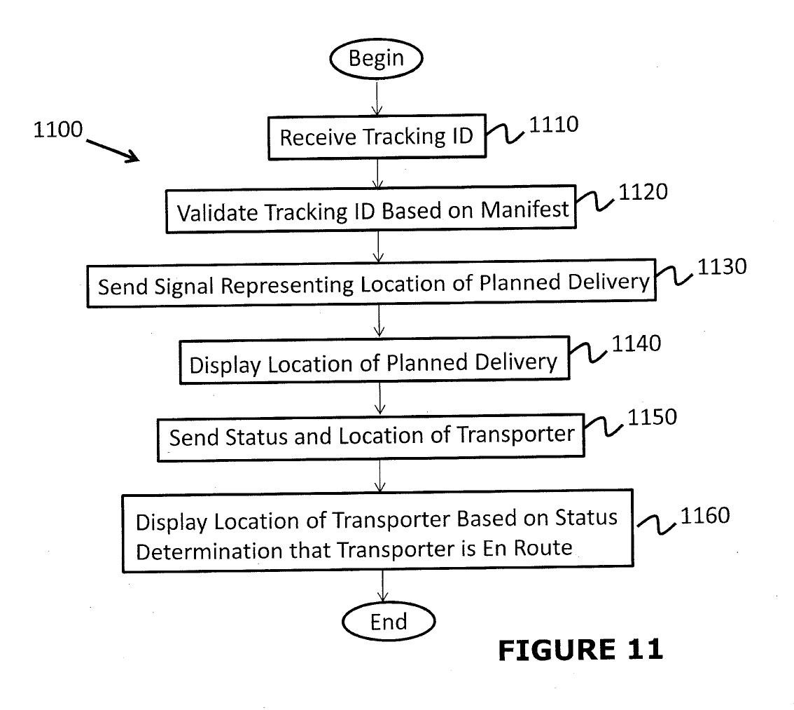

FIG. 11 is a flow diagram of a computer-implemented method in accordance with some embodiments of the present disclosure. After process 1100 begins, a tracking identifier (see FIG. 6), corresponding to a planned delivery of an item, is received (1110). The tracking identifier is validated (1120) based on a manifest 601 associated with a transporter 503. A signal representing a location of the planned delivery of the item is sent (1130) to a mobile device 102 of a planned recipient of the item. For example, the signal may include geocoded address data, or it may include address data that is not geocoded. On a map at the mobile device, the location of the planned delivery is displayed (1140) based on the signal. A status, e.g., one of available (en route), on a break, and off duty, and a location of the transporter are sent (1150) to the mobile device of the planned recipient. The location of the transporter is displayed on the map (1160) based on a status determination that the transporter is en route (available).

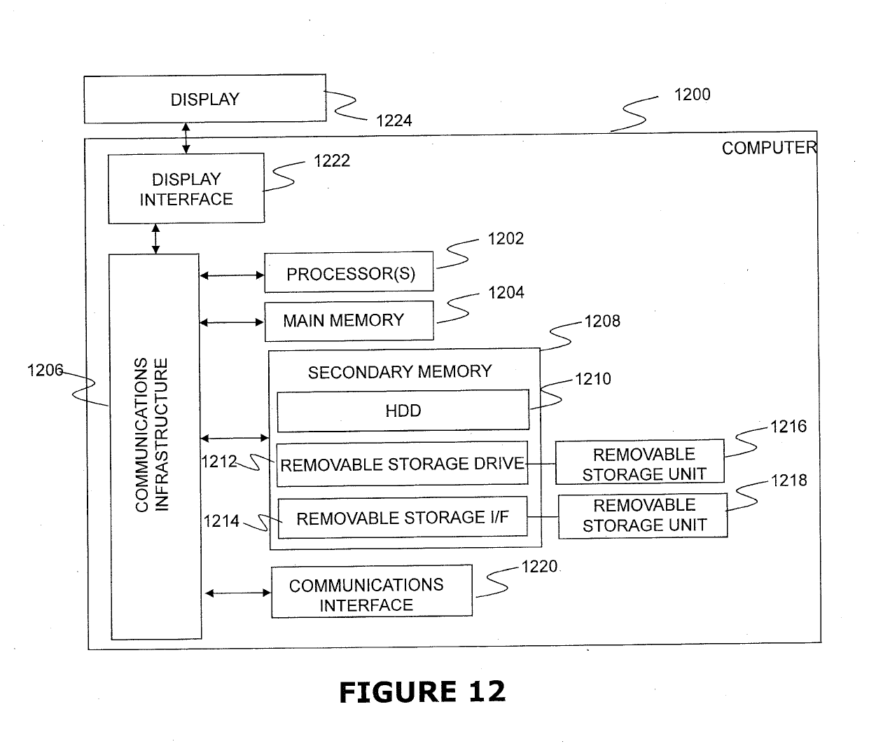

The delivery tracking system in accordance with various embodiments of the present disclosure may be implemented in software and presented to a user on a monitor or other display device. In some embodiments, the delivery tracking system may be presented to a user as a graphical user interface (GUI) on a display device such as a computer monitor. FIG. 12 illustrates one example of an architecture of a computer system 1200 configured to implement the mobile device 102, mobile device 105, and/or server 401a. As illustrated in FIG. 12, computer system 1200 may include one or more processors 1202. The processor 1202 is connected to a communication infrastructure 1206 (e.g., a communications bus, cross-over bar, or network). Computer system 1200 may include a display interface 1222 that forwards graphics, text, and other data from the communication infrastructure 1206 (or from a frame buffer not shown) for display on the display unit 1224, which in some embodiments is a touch screen of a mobile device (e.g., smartphone).

Computer system 1200 also includes a main memory 1204, such as a random access memory (RAM), and a secondary memory 1208. The secondary memory 1208 may include, for example, a hard disk drive (HDD) 1210 and/or removable storage drive 1212, which may represent a floppy disk drive, a magnetic tape drive, an optical disk drive, or the like. The removable storage drive 1212 reads from and/or writes to a removable storage unit 1216. Removable storage unit 1216 may be a floppy disk, magnetic tape, optical disk, or the like. As will be understood, the removable storage unit 1216 may include a computer readable storage medium having stored tangibly therein computer software and/or data.

In alternative embodiments, secondary memory 1208 may include other similar devices for allowing computer programs or other instructions to be loaded into computer system 1200. Secondary memory 1208 may include a removable storage unit 1218 and a corresponding interface 1214. Examples of such removable storage units include, but are not limited to, USB or flash drives, which allow software and data to be transferred from the removable storage unit 1218 to computer system 1200.

Computer system 1200 may also include a communications interface 1220. Communications interface 1220 allows software and data to be transferred between computer system 1200 and external devices. Examples of communications interface 1220 may include a modem, Ethernet card, wireless network card, a Personal Computer Memory Card International Association (PCMCIA) slot and card, or the like. Software and data transferred via communications interface 1220 may be in the form of signals, which may be electronic, electromagnetic, optical, or the like that are capable of being received by communications interface 1220. These signals may be provided to communications interface 1220 via a communications path (e.g., channel), which may be implemented using wire, cable, fiber optics, a telephone line, a cellular link, a radio frequency (RF) link and other communication channels.

In this document, the terms “computer program medium” and “computer readable storage medium” refer to non-transitory media such as removable storage drive 1212, or a hard disk installed in hard disk drive 1210, or any other storage medium. These computer program products provide software to computer system 1200. Computer programs (also referred to as computer control logic) are stored in main memory 1204 and/or secondary memory 1208. Computer programs may also be received via communications interface 1220. Such computer programs, when executed by a processor, enable the computer system 1200 to perform the features of the method discussed herein.

In an embodiment implemented using software, the software instructions may be stored in a computer program product and loaded into computer system 1200 using removable storage drive 1212, hard drive 1210, or communications interface 1220. In other words, the computer program product, which may be a computer readable storage medium, may have instructions tangibly embodied thereon. The software instructions, when executed by a processor 1202, cause the processor 1202 to perform the functions of (operations of) methods described herein.

In another embodiment, the method may be implemented primarily in hardware using, for example, hardware components such as a digital signal processor comprising application specific integrated circuits (ASICs). In yet another embodiment, the method is implemented using a combination of both hardware and software.

While examples of various embodiments have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A computer-implemented method comprising:
receiving a tracking identifier corresponding to a planned delivery of an item;
validating the tracking identifier based on a manifest associated with a transporter;
sending, to a mobile device of a planned recipient of the item, a first signal representing a location of the planned delivery of the item;
displaying, on a map at the mobile device of the planned recipient, the location of the planned delivery of the item, based on said signal;
sending, to the mobile device of the planned recipient, a status and a location of the transporter; and
displaying, on the map, the location of the transporter, based on a status determination that the transporter is en route.

2. The method of claim 1, wherein the status of the transporter is one of en route, on a break, and off duty.

3. The method of claim 2, further comprising:
sending, to the mobile device of the planned recipient, a transporter status notification message indicating that the transporter is not en route.

4. The method of claim 3, wherein the transporter status notification message includes an indication of a next availability time of the transporter.

5. The method of claim 1, further comprising:
calculating a distance between the location of the transporter and the location of the planned delivery; and
displaying, at the mobile device of the planned recipient, a proximity notification message indicating that the calculated distance is less than a predetermined threshold.

6. The method of claim 5, further comprising:
after a missed delivery attempt, sending a missed delivery message to the mobile device of the planned recipient.

7. The method of claim 6, further comprising:
determining the status and the location of the transporter after the missed delivery attempt; and
based on a status determination after the missed delivery attempt that the transporter is en route, displaying, on the map, the location of the transporter, wherein the location of the transporter after the missed delivery attempt is different than the location of the transporter displayed before the missed delivery.

8. The method of claim 1, further comprising:
calculating, at a first time, a first distance between the location of the transporter and the location of the planned delivery;
displaying, at the mobile device of the planned recipient, a first indication that the first distance is less than a first value and greater than a second value;
calculating, at a second time, a second distance between the location of the transporter and the location of the planned delivery; and
displaying, at the mobile device of the planned recipient, a second indication that the second distance is less than the second value.

9. The method of claim 8, wherein the first indication and second indication are displayed in different colors.

10. The method of claim 1, further comprising:
calculating, at a first time, a first distance between the location of the transporter and the location of the planned delivery;
displaying, at the mobile device of the planned recipient, a first indication that the first distance is less than a first value and greater than a second value;
calculating, at a second time, a second distance between the location of the transporter and the location of the planned delivery; and
displaying, at the mobile device of the planned recipient, a second indication that the second distance is less than the second value and greater than a third value.

11. The method of claim 1, further comprising:
based on a status determination that the transporter is not en route, sending a transporter status notification message to the mobile device of the planned recipient.

12. The method of claim 1, further comprising displaying, on the map, a location of the planned recipient.

13. The method of claim 12, wherein the location of the planned recipient is different than the location of the planned delivery.

14. The method of claim 1, wherein said first signal includes address data identifying an address associated with the tracking identifier in the manifest.

15. The method of claim 1, further comprising geocoding an address associated with the tracking identifier in the manifest, to provide geocoded address data, wherein said first signal includes said geocoded address data.

16. The method of claim 1, further comprising:
receiving, at a mobile device of the transporter, an input specifying a duration of an upcoming break for the transporter; and
updating, at a database of a server, the status of the transporter based on the received input.

17. The method of claim 1, further comprising displaying, at the mobile device of the planned recipient, an indication of a position of the item in a delivery queue of the transporter.

18. The method of claim 1, further comprising disabling the display of the location of the transporter on the map at the mobile device of the planned recipient when a predetermined condition is satisfied,

19. The method of claim 18, wherein the predetermined condition is selected from the group consisting of reception of a second signal corresponding to a request from the server to disable the display of the location of the transporter, reception of a third signal corresponding to a request from the transporter to disable the display of the location of the transporter, reception of a fourth signal corresponding to insufficient wireless network accessibility for a mobile device of the transporter, and reception of a fifth signal corresponding to presence of the transporter within or near a predetermined geofence.

20. A system comprising:
a server and a first mobile device, each of the server and first mobile device including a computer processor, a radio transceiver, and a computer readable storage medium, the first mobile device further including a display;
wherein the computer readable storage medium of the server includes computer-executable instructions stored tangibly thereon, said instructions configured to, when executed, cause the processor of the server to perform the operations of:
causing the transceiver of the server to receive, from the first mobile device, a tracking identifier corresponding to a planned delivery of an item,
validating the tracking identifier based on a manifest associated with a transporter,
causing the transceiver of the server to send, to the first mobile device, a signal representing a location of the planned delivery of the item, and
causing the transceiver of the server to send, to the first mobile device, a status and a location of the transporter;
wherein the computer readable storage medium of the first mobile device includes computer-executable instructions stored tangibly thereon, said instructions configured to, when executed, cause the processor of the first mobile device to perform the operations of:
causing the transceiver of the first mobile device to receive the tracking identifier from a user of the first mobile device,
causing the transceiver of the first mobile device to send the tracking identifier to the server,
displaying, on a map on the display of the first mobile device, the location of the planned delivery of the item, based on the signal received from the server, and
displaying, on the map, the location of the transporter.

21. The system of claim 20, wherein the instructions stored on the storage medium of the server are further configured to, when executed, cause the processor of the server to perform the operation of calculating a distance between the location of the transporter and the location of the planned delivery;
wherein the instructions stored on the storage medium of the first mobile device are further configured to, when executed, cause the processor of the first mobile device to perform the operation of displaying, at the display of the mobile device, an electronic proximity notification message indicating that the distance is less than a predetermined threshold.

22. The system of claim 20, wherein the instructions stored on the storage medium of the first mobile device are further configured to, when executed, cause the processor of the first mobile device to perform the operations of:
calculating a distance between the location of the transporter and the location of the planned delivery; and
displaying, at the display of the mobile device, an electronic proximity notification message indicating that the calculated distance is less than a predetermined threshold.

23. The system of claim 20, wherein the instructions stored on the storage medium of the server are further configured to, when executed, cause the processor of the server to perform the operation of causing the transceiver of the server to send, after a missed delivery attempt, a missed delivery message to the first mobile device.

24. The system of claim 20, wherein the instructions stored on the storage medium of the server are further configured to, when executed, cause the processor of the server to perform the operation of causing the transceiver of the server to send a transporter status notification message to the first mobile device based on a status determination that the transporter is not en route.

25. The system of claim 20, wherein the instructions stored on the storage medium of the first mobile device are further configured to, when executed, cause the processor of the first mobile device to perform the operation of displaying, on the map, a location of the user of the first mobile device.

26. The system of claim 20, wherein said signal includes address data identifying an address associated with the tracking identifier in the manifest;
wherein the instructions stored on the storage medium of the first mobile device are further configured to, when executed, cause the processor of the first mobile device to perform the operation of geocoding the address data, wherein the location of the planned delivery of the item is displayed on the map based on the geocoded address data.

27. The system of claim 20, wherein the instructions stored on the storage medium of the server are further configured to; when executed, cause the processor of the server to perform the operation of geocoding an address associated with the tracking identifier in the manifest, to provide geocoded address data, wherein said signal includes said geocoded address data.

28. The system of claim 20, further comprising a second mobile device including a computer processor, a radio transceiver, a computer readable storage medium, and a display;
wherein the computer readable storage medium of the second mobile device includes computer-executable instructions stored tangibly thereon, said instructions configured to, when executed, cause the processor of the second mobile device to perform the operations of:
receiving, from the transporter, an input specifying a duration of an upcoming break for the transporter; and
causing the processor of the second mobile device to send said input to the server;
wherein the instructions stored on the storage medium of the server are further configured to, when executed, cause the processor of the server to perform the operation of updating, at a database of the server, the status of the transporter based on said input received from the second mobile device.

29. The system of claim 20, wherein the instructions stored on the storage medium of the second mobile device are further configured to, when executed, cause the processor of the second mobile device to perform the operation of sending, to the server, location information specifying the location of the transporter.

30. The system of claim 20, further comprising a tracking device including:
a receiver configured to receive a positioning signal;
a computer processor configured to determine a location of the tracking device based on the received positioning signal; and
a transmitter configured to transmit to the server a tracking signal representing the location of the tracking device;
wherein the tracking device is located within a package comprising the item or is coupled to said package.
